(19) United States
(12) Patent Application Publication
(10) Pub. No.: US 2010/0313437 A1
(43) Pub. Date: Dec. 16, 2010

(54) Screw guide for pre-drilled holes in hinges

(76) Inventor: Eric J. Cherchio, Bayonne, NJ (US)

Correspondence Address: EZRA SUTTON & ASSOCIATES, P.A.;Suite 201, 900 Route 9 North, Woodbridge, NJ, 07095, US

(21) Appl. No.: 12/456,358

(22) Filed: Jun. 16, 2009

(51) Int. Cl. G01B 1/00; B28B 19/00

(52) U.S. Cl. 33/562; 264/269

(57) ABSTRACT

The present invention is for a plastic screw guide formed in the pre-drilled holes of any hinge for centering screws without any pre-punching. The plastic screw guide may be sold separately or manufactured directly into the pre-drilled holes of any hinges, lock sets, or any securing device that can be fitted into any wooden or composite material. The plastic or Teflon material of the disposable screw guide is driven in with a screw gun, drill, or like securing device. The melted plastic lubricates the screw during drilling and the unused plastic material dissolves from the heat.

### FIELD OF THE INVENTION

The present invention is for a plastic screw guide formed in the pre-drilled holes of any hinge for centering screws without any pre-punching. The plastic screw guide may be sold separately or manufactured directly into the pre-drilled holes of any hinges, lock sets, or any securing device that can be fitted into any wooden or composite material. The plastic or Teflon material of the disposable screw guide is driven in with a screw gun, drill, or like securing device. The melted plastic lubricates the screw during drilling and the unused plastic material dissolves from the heat.

### BACKGROUND OF THE INVENTION

The prior art does not provide a screw guide having a pre-formed centering hole in the center of the guide to provide a screw guide for centering screws to be drilled.

In present practice, when a carpenter installs a door, three sets of heavy duty hinges are used, each hinge having 8 holes, for a total of 24 holes for receiving screws. If the 24 screws are not properly installed in the center of each of the 24 pre-drilled holes of the hinges, the screw head will not be flush with the pre-drilled holes in the hinge, which could cause problems with the door being properly aligned, and the door will not close properly.

Therefore, a simple and easy to use screw guide is necessary for automatically centering the screw to be drilled into each pre-drilled hole of the hinge, without any measuring, aligning, or pre-punching being necessary, which is a time consuming process for the installer.

It is an object of the present invention to provide a plastic screw guide which is pre-formed in the pre-drilled holes of any hinge for centering screws automatically without any measuring, aligning, or pre-punching. This saves the installer or carpenter a great deal of time, especially when 24 screws must be accurately centered in 24 holes for each door.

### SUMMARY OF THE INVENTION

The present invention is for a plastic screw guide formed in the pre-drilled holes of any hinge for centering screws without any pre-punching. The plastic screw guide may be sold separately or manufactured directly into the pre-drilled holes of any hinges, lock sets, or any securing device that can be fitted into any wooden or composite material. The plastic or Teflon material of the disposable screw guide is driven in with a screw gun, drill, or like securing device. The melted plastic lubricates the screw during drilling and the unused plastic material dissolves from the heat.

### BRIEF DESCRIPTION OF THE DRAWINGS

Further objects, features and advantages of the present invention will become apparent upon the consideration of the following detailed description of the presently preferred embodiment when taken in conjunction with the accompanying drawings, wherein:

FIG. 1 shows the plastic screw guides for centering screws in the pre-drilled holes of a hinge, with each screw guide having a pre-formed guide hole in the center of each hole in the hinge.

FIG. 2 shows a holding plate for receiving and aligning the hinge set for receiving the plastic screw guides in the holes of the hinge set.

### DETAILED DESCRIPTION OF THE PREFERRED EMBODIMENT

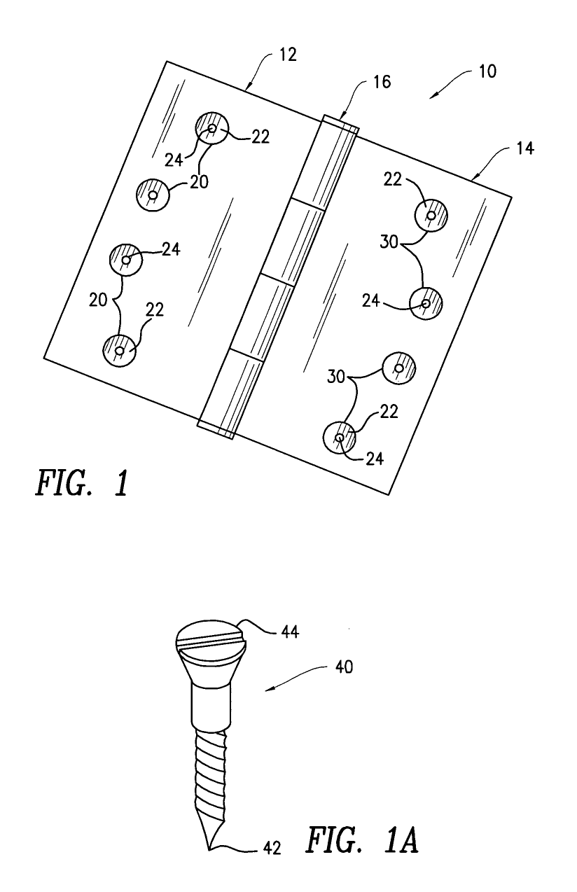

Referring to FIG. 1, it shows a typical heavy duty hinge set 10 having hinge plates 12 and 14 connected by a conventional hinge 16. In hinge plate 12 there are 4 pre-drilled hinge holes 20, and in hinge plate 14 there are 4 pre-drilled hinge holes 30.

Each of the hinge holes 20 and 30 has a plastic screw guide 22 pre-formed in each hinge hole. The screw guide has a pre-formed centering hole 24 for receiving and centering a screw 40 to be drilled, typically with a high speed drill. The preformed centering hole 24 has a diameter which is of a sufficient size to hold the tip of the screw embedded in the surrounding plastic material of the screw guide 22, so the screw does not have to be held in place before the drilling starts. As will be understood, the diameter will vary with the size of the screw.

As a result of this invention, no pre-punching, aligning or measuring is necessary for the installer. These time-consuming steps are avoided with the present invention. The installer merely places the tip 42 of screw 40 in the pre-formed centering hole 24 in each screw guide 22, and begins drilling. In this manner, the head 44 of screw 40 will be centered in the hole 20, and the head 44 will be flush with the surface of hinge plate 12.

Screw guide 22 is formed with any plastic material or plastic composite having a low melting point which allows the plastic to melt from the friction and heat caused by the screw heating up during the drilling process. In this manner, the plastic lubricates the screw, and makes it easier to drill, and helps to present the screw from snapping during the drilling process, as commonly occurs. The plastic material dissolves from the heat of the drilling. One type of plastic that works well is Teflon. The plastic has the consistency of a wax material.

Screw guide 22 is formed by heating and melting the plastic material into a liquid state, and then placing the liquid plastic in each of the pre-drilled hinge holes, and then allowing the plastic material to cool and harden, and then removing any excess plastic from around hole 20. A pin or peg is placed in the center of each hole 20 to pre-form the centering hole 24 in each screw guide 22.

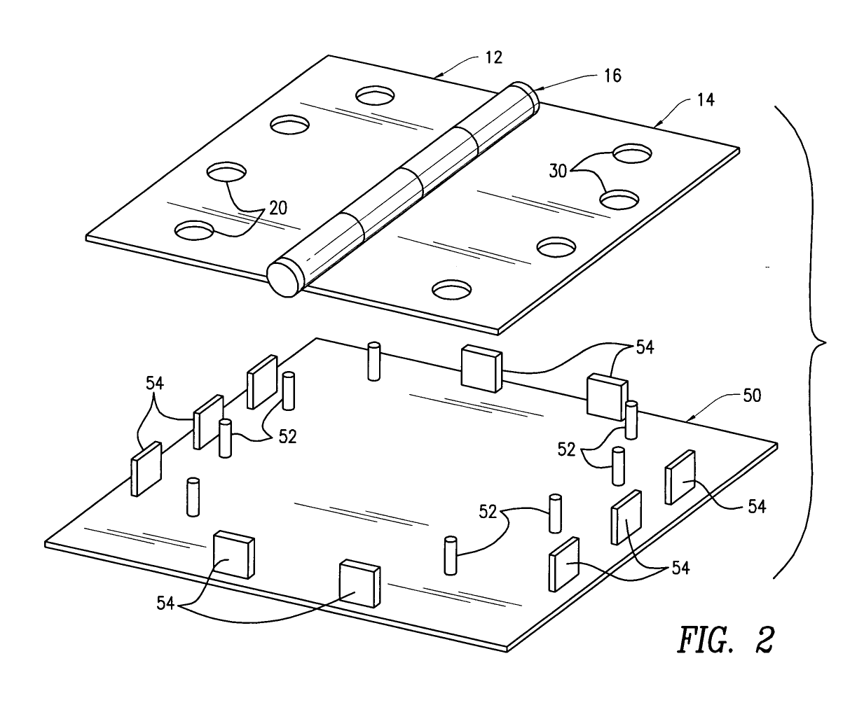

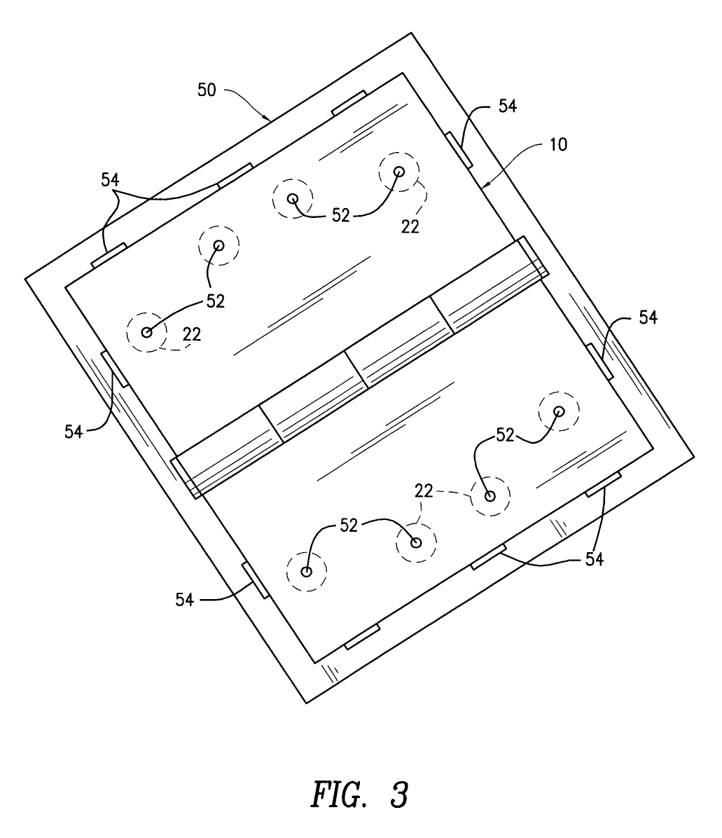

In the method of making the screw guides 22, a holding plate 50 is used for receiving hinge set 10, and the plate has eight upstanding pegs or pins 52 formed on the surface of plate 50 for forming the centering holes 24. When the hinge set 10 is placed on the surface of holding plate 50, the pins or pegs 52 are automatically aligned in the center of each screw guide 22. This step is simplified by holding plate 50 having guide posts 54 along the periphery of the hinge set 10, as shown in FIG. 2, for receiving and centering hinge set 10, so that pins 52 are automatically aligned in the center of each hinge hole 20. After this step, the melted plastic material is placed into each of the hinge holes 20 and 30, and the plastic is allowed to cool and harden to pre-form centering holes 24. Then, hinge set 10 is removed from the holding plate 50, with each hinge hole 20 and 30 having a screw guide 22 formed therein, and with each screw guide 22 having a centering hole 24 formed therein.

The present invention also has application in lock sets wherein the screw holes are provided with plastic screw guides 22 of the present invention.

### ADVANTAGES OF THE PRESENT INVENTION

The advantage of the present invention is that it has provided a plastic screw guide which is pre-formed in the pre-drilled holes of any hinge for centering screws automatically without any measuring, aligning, or pre-punching. This saves the installer or carpenter a great deal of time, especially when 24 screws must be accurately centered in 24 holes for each door.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. A plastic screw guide for centering screws in a hinge; comprising:
a) a hinge having a plurality of screw holes each for receiving a screw;
b) a screw guide in each of the hinge holes formed of plastic material which fills the entire hinge hole, except for the center of the hinge hole;
c) a screw receiving centering hole formed in the center of said screw guide for receiving and centering the tip of a screw to be drilled or screwed into the hinge hole.

2. A plastic screw guide in accordance with claim 1, wherein said centering hole has a diameter which is of a sufficient size to hold the tip of a screw embedded in the surrounding plastic material, so the screw does not have to be held in place before the drilling starts.

3. A plastic screw guide in accordance with claim 1, wherein said screw guide is formed of plastic or Teflon and has the consistency of wax material.

4. A method of making a screw guide in a hinge, comprising;
a) placing the hinge on a holder having a receiving surface, wherein the holder has upstanding pins formed on the receiving surface for being received within the center of each hinge hole, and wherein the holder has outer guide devices formed on the receiving surface for centering the hinge on the holder, so that each of said pins are automatically aligned within the center of each hinge hole; and
b) placing melted plastic material in each hinge hole and allowing it to cool to form said screw guide and a centering hole in said screw guide.
